(19) United States
(12) Patent Application Publication
(10) Pub. No.: US 2009/0070215 A1
(43) Pub. Date: Mar. 12, 2009

(54) Advertising Method

(76) Inventor: Henryk Strzeletz, Dallas, PA (US)

Correspondence Address: GREENBERG & LIEBERMAN, LLC, 2141 WISCONSIN AVE, N.W., SUITE C-2, WASHINGTON, DC, 20007, US

(21) Appl. No.: 12/047,109

(22) Filed: Mar. 12, 2008

Related U.S. Application Data
(60) Provisional application No. 60/894,351, filed on Mar. 12, 2007.

(51) Int. Cl. G06Q 30/00

(52) U.S. Cl. 705/14

(57) ABSTRACT

A mobile information resource, the present invention provides programming along with advertisements. The advertisements appear in place of programming or alongside programming, allowing viewers to contact advertisers were ever the programming is being shown. Advertisers can dynamically choose the time, date, locations, conditions, and other variables concerning when ads are shown.

This is a non-provisional patent application of provisional patent application No. 60/894,351, filed on Mar. 12, 2007, and priority is claimed thereto.

### FIELD OF THE INVENTION

The present invention concerns advertising, and more particularly, the present invention is an advertising method that provides advertising in the mobile setting on demand where at least one phone number is displayed and an advertiser is charged every time a viewer calls that particular phone number.

### BACKGROUND OF THE INVENTION

Advertising can take many forms—it can be signs on top of taxis; it can be commercials on television; and they can even be pay per click advertisements on the Internet. The advantage of signs on top of taxis is that they are mobile, and that means that an advertisement can be displayed anywhere so long as the taxi can travel to a location. The advantage of commercials on television is that they are electronically visual with moving images, and oftentimes, are paid great attention to because they are promoted during programming of interest to a viewer. The advantage of pay per click advertisements on the Internet is that, unlike the aforementioned types of advertising, Internet pay per click advertising allows the advertiser to pay only when someone clicks on the advertiser's advertisement.

In short, it would be desirable to have a method of advertising whereby the advantages of all the aforementioned advertising types could be appreciated. Mobility in advertising means that an advertisement can be outside the stadium, near an emergency situation, or in a one time highly frequented location. Mobile advertising is highly desirable because the advertisement is literally placed where the advertiser wants to be seen. Visually moving advertising provided during programming captures the viewer's attention unlike any other type of advertising. For example, commercials are highly desirable because they are viewed by a captive audience waiting for a program to continue. And pay per click advertising means that the advertiser is paying directly in proportion to traffic, as opposed to a fixed rate independent of the effectiveness of the advertisement. When an advertiser pays directly in proportion to viewers paying attention to the advertisement, the advertiser feels that any payment for the advertisement is justified. There is no advertising method that combines all three characteristics of the aforementioned advertising.

The need has been established for an advertising method that synergistically combines mobility, a captive audience, and a cost associated with viewers paying attention to the advertisement. Mobility in advertising is far from new, simply driving around a city with an advertisement does not target a captive audience and has no concept of a cost associated with viewers paying attention to the advertisement. In short, mobile advertising generally has a fixed cost. Having a captive audience view an advertisement is not out of the ordinary, however captive audiences are usually stationary. Charging an advertiser depending upon viewers' interest in an advertisement is very common on the Internet, although outside the Internet medium, it is completely unexplored.

### SUMMARY OF THE INVENTION

The present invention is an advertising method that takes the pay per click concept of the Internet and makes it mobile for a captive audience. The present invention provides programming on the side of a vehicle. Commercials or other advertisements then run simultaneously with the programming, or alternatively, the commercials or other advertisements run in columns or rows bordering the programming.

Much like pay per click advertisements on the Internet, but commercials or other advertisements of the present invention can be changed on demand according to how much an advertiser desires to bid. In the present invention, because commercials or other advertisements are not clickable, phone numbers are provided for the viewers to call for each commercial or other advertisement. When a viewer calls a phone number that has been shown in a commercial or other advertisement, the advertiser is then charged for the present invention bringing that call to the advertiser. The charge that the advertiser pays is preferably a cost that the advertiser bid on so that the advertiser's commercial or other advertisement would show to viewers according to the present invention.

Essentially, the present invention has moved the concept of pay per click advertising that has found so much acceptance on the Internet into mainstream media. And then, the present invention takes that concept one step farther, by making it displayable on mobile screens. According to the present invention, a fleet of trucks could be deployed and positioned at various times in various areas. Programming would be run on the sides of the trucks, the trucks configured to display programming much like a television set does. Advertisers could bid for certain sized advertisements, adds a certain durations, and even spots for commercials on demand. The advertisers would pay for the advertisements each time a viewer calls the phone number in the advertisement. With the advent and popularity of mobile phone technology, the present invention is uniquely positioned to take advantage of the ability for users to contact advertisers instantly, associating costs of advertisements with user feedback.

### BRIEF DESCRIPTION OF THE DRAWINGS

FIG. 1 is a flowchart of the general scheme of the present invention.

FIG. 2 shows a sample screen of the present invention, illustrating programming in combination with advertisements.

FIG. 3 is a flow chart showing how advertisers place advertisements in the present invention.

### DETAILED DESCRIPTION OF THE PREFERRED EMBODIMENT(S)

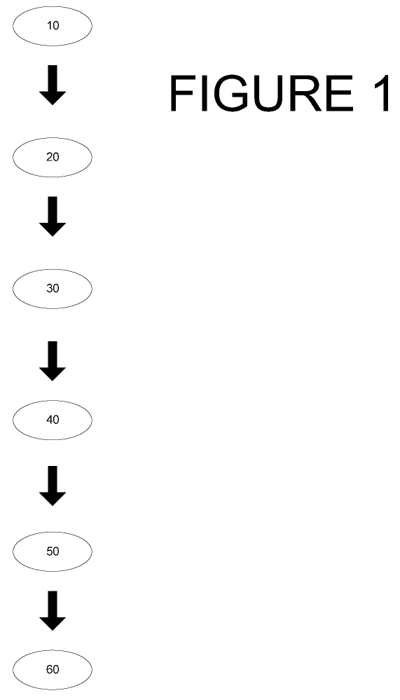

As shown in FIG. 1, a vehicle is deployed 10 to any location where a displaying advertisements is desired. Bridges, tunnels, highways, and even fields are prime examples of locations where a vehicle is deployed 10. The vehicle of the present invention also is referred to as a truck because a truck is the most likely type of vehicle to work with the present invention. It is envisioned that the vehicle, or truck, can be at least one vehicle. When a truck is deployed 10, the truck does not need to be fixed in one location. If there is an emergency situation, a truck is deployed 10 such that the truck moves through traffic, indicating emergency status and emergency traveling rounds, for example. In this example, the truck could guide cars around an emergency situation or bring rescue vehicles directly to an emergency situation. The truck has at least one display screen 99. It should be noted that the present invention envisions that the vehicle, again, also referred to as a truck, is not necessary as the present invention can be displayed and presented on a stationary item as well. The vehicle aspect is merely a preferred embodiment.

Once a truck is deployed 10, programming is transmitted to the truck 20. The programming also is referred to as a non-advertisement. The programming can be any type of programming desired. The programming can be commercial television, live camera views of a scene, or even special messaging appropriate for emergency conditions. Preferably, the programming is selected to be that which is desired to be viewed by an audience at the location to which a truck is deployed 10. Programming is transmitted to the truck 20 via any conventional means. The programming is shown on the display screen 99 of the truck.

Next, advertisements are displayed on the display screen 99 along with programming 30. The advertisements can be in the form of commercials, literally interrupting the programming. Alternatively the advertisements can run alongside the programming, such that the programming is framed by the advertisements. Also the advertisements can be the main focus, such that the advertisements are framed by the programming. The screen can be of any conventional technology.

Phone numbers provided with advertisements 40 provide a link between the advertisements displayed on the screen along with programming 30 and a revenue stream. When a viewer watches advertisements displayed on the screen along with programming 30, the viewer can call a phone number provided within advertisements 50 to either order or gain more information about a product or service. Preferably, the phone number provided with advertisements 40 is unique for a certain truck that is deployed 10, so that the truck that is deployed 10 can be identified as the source prompting a viewer to call a phone number provided within advertisements 50. For example, in one embodiment of the present invention, an advertiser could show the same advertisement on the display screens 99 of multiple vehicles. If a viewer were to call the phone number contained in an advertisement, the phone number would be the same because the same phone number is displayed on each of the display screens 99 of each of the vehicles. Alternatively, in another embodiment of the present invention, the same advertisement could be run on the display screens 99 of multiple vehicles; however, the phone number in each advertisement would vary. In other words, each advertisement on each display screen 99 of each vehicle would have a unique phone number, so that when a viewer calls a phone number, the actual display screen 99 and vehicle responsible for showing a unique phone number could be identified.

Each time a viewer calls a phone number provided within advertisements 50, advertisers are charged for a call 60. For example, if a viewer is watching programming transmitted to a truck 20, such as a football game, the viewer would see advertisements displayed on the screen along with programming 30. The advertisement might be for an official football team jersey, and if interested, the viewer would see the phone number provided with advertisements 40, and the viewer would call a phone number provided within advertisements 50. When the viewer calls a phone number provided within advertisements 50, the advertiser is charged for a call 60. When the advertiser is charged for a call 60, the revenue stream for the present invention has been realized. In other words, the present invention generates call traffic to advertisers, and when the advertiser is charged for a call 60, the present invention generates money for the owner/operator of the present invention.

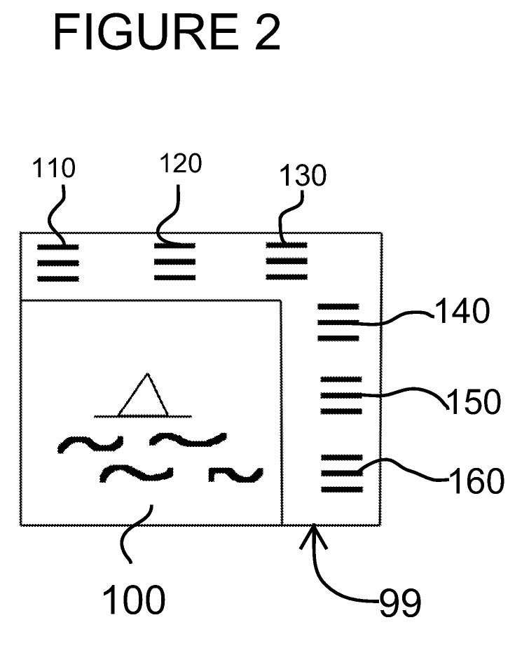

As shown in FIG. 2, a typical display screen 99 of the present invention has been broken down for understanding. First advertisement 110, second advertisement 120, and third advertisement 130 are displayed in a top row along the top of a typical screen of the present invention. Fourth advertisement 140, fifth advertisement 150, and sixth advertisement 160 are displayed in a side column along the side of a typical screen of the present invention. A preferred embodiment of the present invention has first advertisement 110, second advertisement 120, third advertisement 130, fourth advertisement 140, fifth advertisement 150, and sixth advertisement 160 essentially forming a border around programming 100, also referred to as the non-advertisement, of the present invention. Preferably, programming 100 can continue without interruption as first advertisement 110, second advertisement 120, third advertisement 130, fourth advertisement 140, fifth advertisement 150, and sixth advertisement 160 remain uninterrupted while programming 100 continues. Each of first advertisement 110, second advertisement 120, third advertisement 130, fourth advertisement 140, fifth advertisement 150, and sixth advertisement 160 has preferably a few lines of text/picture/video adjacent to a phone number so that the viewer can contact the advertiser. It should be understood that according to the present invention, advertisers can pay either a fixed amount or a variable amount for advertisements. Much like the pay per click advertising on the Internet, advertisers could bid for different positions along a column or border surrounding the programming 100 of the present invention. For example, first advertisement 110, second advertisement 120, third advertisement 130, fourth advertisement 140, fifth advertisement 150, and sixth advertisement 160 could have different costs associated with each of them. First ad 110 would be the advertisement position for the advertiser who bids the most, whereas second advertisement 120 would be the advertisement position for the advertiser who bids more than all the other advertisers but for the advertiser at first advertisement 110. The advertisers at different ad positions could vary per second or per minute depending on how often advertisers change their bids for the different ad positions. Realistically, advertisers might have to hold a certain position for a fixed period of time because if first advertisement 110, second advertisement 120, third advertisement 130, fourth advertisement 140, fifth advertisement 150, and sixth advertisement 160 constantly change every few seconds, the viewer would find it impossible to call a phone number displayed along with one of the advertisements.

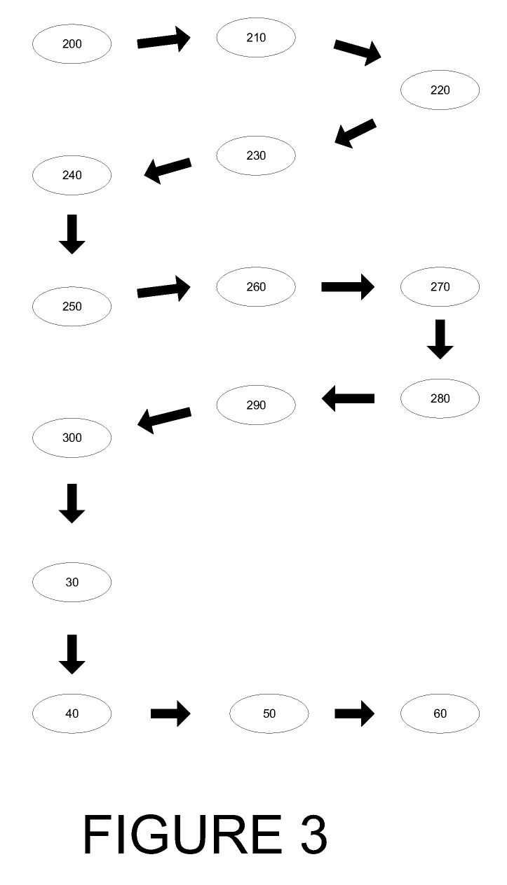

FIG. 3 shows how advertisement are placed according to the present invention. To begin the establishment of an account 200, the advertiser provides financial information 210 such as a credit card that can be charged each time viewers call the advertiser's phone number. The advertiser provides the substance of the advertisement to 220, which is the text/picture/video of the advertisement. The advertiser also provides or is assigned a viewer contact number 230 that charges the advertiser's account each time a viewer calls the provided or a sign the viewer contact number 230. Once the aforementioned information has been provided and set up, the establishment of an account has ended 240.

The next step in placing at least one advertisement according to the present invention is to begin advanced establishment account 250. The advertiser, also referred to as at least one advertiser, chooses the runtime 260 of the advertiser's advertisement. The runtimes could be predetermined, for example, if the advertiser is running a commercial that has a fixed duration. Alternatively, the runtimes could vary depending upon the advertiser's preference. Also, the advertiser chooses the run date 270 of the advertiser's advertisement. For example, the advertiser could choose to run advertisements Monday through Friday, every Sunday afternoon, or during a fixed week. The advertiser also chooses the run locations 280 of the advertisement linked with the at least one advertiser. This means that the advertiser can choose to run an advertisement, for example, in certain suburbs, in downtown areas, or on major interstates. Additionally, the advertiser chooses the run conditions 290 of the advertiser's advertisement. This means that the advertiser can choose to run an advertisement, for example, during a snowstorm, during a time of heightened homeland security, or during a holiday period. Once the aforementioned information has been provided and set up, the advanced establishment of an account has ended 300.

The latter portion of FIG. 3 is similar to the latter portion of FIG. 1. That is, after advanced establishment of an account, advertisements are displayed on a screen along with programming 30. A phone number provided with advertisements 40 allows the viewer to call a phone number provided within advertisements 50 while advertisers are charged for call 60.

It is to be understood that the advertisements, phone number, advertisers and display screen 99 can be referred to in the singular form or plural. The key point is that merely at least one of these items is necessary. So it is to be understood that advertisements also are referred to as at least one advertisement, phone number and phone numbers also are referred to as at least one phone number, advertisers also are referred to as at least one advertiser, and display screen 99 also is referred to as at least one display screen 99. Also, it should be noted that a display screen 99 could be any screen with a means for display, such as a cell phone screen. If a cell phone screen were the display screen 99, then the first advertisement 110, second advertisement 120, third advertisement 130, fourth advertisement 140, fifth advertisement 150, and sixth advertisement 160 could be displayed as part of a background image on the cell phone screen. Alternatively, if a cell phone screen were the display screen 99, then the first advertisement 110, second advertisement 120, third advertisement 130, fourth advertisement 140, fifth advertisement 150, and sixth advertisement 160 could be displayed as a screen saver.

In essence the present invention is an advertising method where at least one advertisement, corresponding with at least one advertiser, is displayed on at least one display screen 99. This at least one advertiser is linked to at least one phone number that is displayed and positioned within at least one advertisement. The advertiser is effectively charged based on the above description for each time a call is placed to the at least one phone number. It is important to note that the at least one advertisement can be displayed on the at least one display screen 99 that rests on a stationary item. However, the preferred embodiment of the present invention envisions that vehicles such as trucks will be deployed 10 to a location with the at least one display screen 99 positioned on the vehicle. The at least one advertisement may then be transmitted to the at least one display screen 99. A non-advertisement, also referred to in this description as programming, also is transmitted and displayed to at least one display screen 99. The non-advertisement is displayed adjacent to the at least one advertisement. In addition, the at least one advertisement is displayed around the non-advertisement as the description above describes. Meanwhile, at least one advertiser provides at least one bid for placement of the at least one advertisement on the at least one display screen 99.

I claim:

1. An advertising method, comprising:
displaying at least one advertisement on at least one display screen, the at least one advertisement corresponding to at least one advertiser;
displaying at least one phone number linked to the at least one advertiser, the at least one phone number is positioned within the at least one advertisement; and
charging the at least one advertiser each time a call is placed to the at least one phone number.

2. The advertising method of claim 1, further comprising deploying a vehicle to a location, the at least one display screen positioned on the vehicle.

3. The advertising method of claim 1, further comprising transmitting the at least one advertisement to the at least one display screen.

4. The advertising method of claim 1, further comprising displaying a non-advertisement.

5. The advertising method of claim 4, further comprising transmitting the non-advertisement to the at least one display screen.

6. The advertising method of claim 4, further comprising displaying a non-advertisement adjacent to the at least one advertisement.

7. The advertising method of claim 4, further comprising displaying the at least one advertisement around the non-advertisement.

8. The advertising method of claim 1, further comprising receiving at least one bid by the at least one advertiser for placement of the at least one advertisement on the at least one display screen.

9. The advertising method of claim 2, further comprising transmitting the at least one advertisement to the at least one display screen.

10. The advertising method of claim 2, further comprising displaying a non-advertisement.

11. The advertising method of claim 10, further comprising transmitting the non-advertisement to the at least one display screen.

12. The advertising method of claim 10, further comprising displaying a non-advertisement adjacent to the at least one advertisement.

13. The advertising method of claim 10, further comprising displaying the at least one advertisement around the non-advertisement.

14. The advertising method of claim 2, further comprising receiving at least one bid by the at least one advertiser for placement of the at least one advertisement on the at least one display screen.

15. An advertising method, comprising:
displaying at least one advertisement on at least one display screen, the at least one advertisement corresponding to at least one advertiser;
displaying at least one phone number linked to the at least one advertiser, the at least one phone number is positioned within the at least one advertisement;
charging the at least one advertiser each time a call is placed to the at least one phone number;
further comprising deploying a vehicle to a location, the at least one display screen positioned on the vehicle;
further comprising transmitting the at least one advertisement to the at least one display screen;
further comprising displaying a non-advertisement;
further comprising transmitting the non-advertisement to the at least one display screen;
further comprising displaying a non-advertisement adjacent to the at least one advertisement;
further comprising displaying the at least one advertisement around the non-advertisement; and
further comprising receiving at least one bid by the at least one advertiser for placement of the at least one advertisement on the at least one display screen.

16. An advertising method, comprising:
deploying a vehicle to a location;
transmitting programming to the vehicle;
targeting the programming to an intended audience;
displaying the programming on at least one display screen of the vehicle;
displaying advertisements on the at least one display screen of the vehicle, the advertisements appearing on the at least one display screen along with the programming;
displaying phone numbers within the advertisements, the advertisements being initiated by advertisers; and
charging the advertisers each time a viewer calls the phone numbers.
